(19) United States
(12) Patent Application Publication
(10) Pub. No.: US 2008/0156960 A1
(43) Pub. Date: Jul. 3, 2008

(54) Truck seat suspension

(76) Inventors: Paul A. Elio, Phoenix, AZ (US); Hari Sankara Iyer, Scottsdale, AZ (US); Robert E. Glaspie, Scottsdale, AZ (US)

Correspondence Address: Daniel H. Steidl;KILGANNON & STEIDL, 85 Pondfield Road, Bronxville, NY, 10708, US

(21) Appl. No.: 11/648,395

(22) Filed: Dec. 29, 2006

(51) Int. Cl. F16M 13/00

(52) U.S. Cl. 248/564

(57) ABSTRACT

A truck seat suspension with scissors linkages. Each channel-in-channel scissor arm has a first C-section channel member opening in a first lateral direction, a second C-section channel member opening in the opposite lateral direction, the second C-section channel nesting within the first C-section channel member to provide abutting double flanges at the top and bottom of each scissor arm, and the first and second C-section channels welded to each other adjacent the abutting flanges. Enhanced bending stiffness, torsional properties, lateral stability and mass reduction are obtained compared to solid plate scissor arms.

### FIELD OF THE INVENTION

This invention relates to a truck seat suspension, and more particularly to such a suspension utilizing scissors linkages.

### BACKGROUND OF THE INVENTION

Truck seat suspensions with scissors linkages have been well known for many years. The bottom of the seat suspension is generally mounted upon tracks or a mounting base in turn mounted to the truck floor. The truck seat itself and any intervening mechanisms (i.e., reclining and isolation mechanisms, etc.) are in turn generally mounted upon the top of the seat suspension.

In a conventional configuration of such suspensions, the scissors linkages have one scissor with a pair of crossing scissor arms on each side of the suspension. These scissor arms in the past have comprised flat metal solid plates, or tubular members, etc. Each form of construction has its advantages and disadvantages. However, it is presently desirable to provide truck seat suspensions resistant to increased loads (for example, as occurring in all belts to seat configurations) and that provide more comfort and safety to the driver. There is a need for a new design of scissor arms providing advantageous bending stiffness and torsional properties at an advantageous weight and cost compared to prior scissor arm designs.

### SUMMARY OF THE INVENTION

The present invention comprises crossing scissor arms on each side of the suspension to form two scissors and four arms in total. Each scissor arm is formed of first and second C-sections having their channel openings between their top and bottom flanges facing in opposite lateral directions. The first C-section in each arm is dimensioned between its top and bottom flanges to allow the second C-section to nest between the top and bottom flanges of the first C-section and provide a channel-in-channel section. The top and bottom flanges of the second C-section respectively abut the top and bottom flanges of the first C-section in such nesting. Double flanges are thus formed at the top and bottom of each resulting scissor arm to provide a maximum bending stiffness of the arm approximating the benefits of an I-beam. The first and second C-sections of each arm are also welded together to provide a structure that approximates the beneficial torsional rigidity properties of a tube. Each of the C-sections forming each scissor arm generally increases in dimension between its top and bottom flanges from the opposite ends of the C-section toward the central crossing position of the two arms in each scissor.

A channel-in-channel scissor arm of the present invention, when compared with a flat solid plate scissor arm, provides equivalent primary moments of inertia, several times the secondary bending moment of inertia and several times the torsional constant. In addition the channel-in-channel arm is significantly lighter as a result of using less material to provide a significant cost saving for each arm and thereby much more so for each suspension having four of such arms.

Other features and advantages of the present invention will be apparent from the following description, drawings and claims.

### BRIEF DESCRIPTION OF THE DRAWINGS

FIG. 1 is a perspective view of a conventional truck seat suspension with scissors linkages and having a single C-section channel member for each of the four scissor arms;

FIG. 2 is a perspective view of a reversed channel-in-channel scissor arm of the present invention shown at the lower right and further illustrating in FIG. 2A the manner in which said channel-in-channel arm is formed from a first larger C-section channel member facing in one lateral direction, a second smaller C-section channel member facing in the opposite lateral direction, and the smaller C-section channel member nested within the channel of the first C-section channel member;

FIG. 3 is cross-sectional view along lines 3-3 of FIG. 2 and further illustrating the structures and forming of the channel-in-channel scissor arm of the present invention;

FIG. 4 is a perspective view of a truck seat suspension with scissors linkages and having four channel-in-channel scissor arms of the present invention made according to FIGS. 2 and 3; and

FIG. 5 is an illustration of the channel-in-channel scissor arm of the present invention compared with a flat solid plate arm having equivalent primary moments of inertia and enhanced bending stiffness and torsional properties, both scissor arms being shown in cross sections.

### DETAILED DESCRIPTION OF AN EMBODIMENT

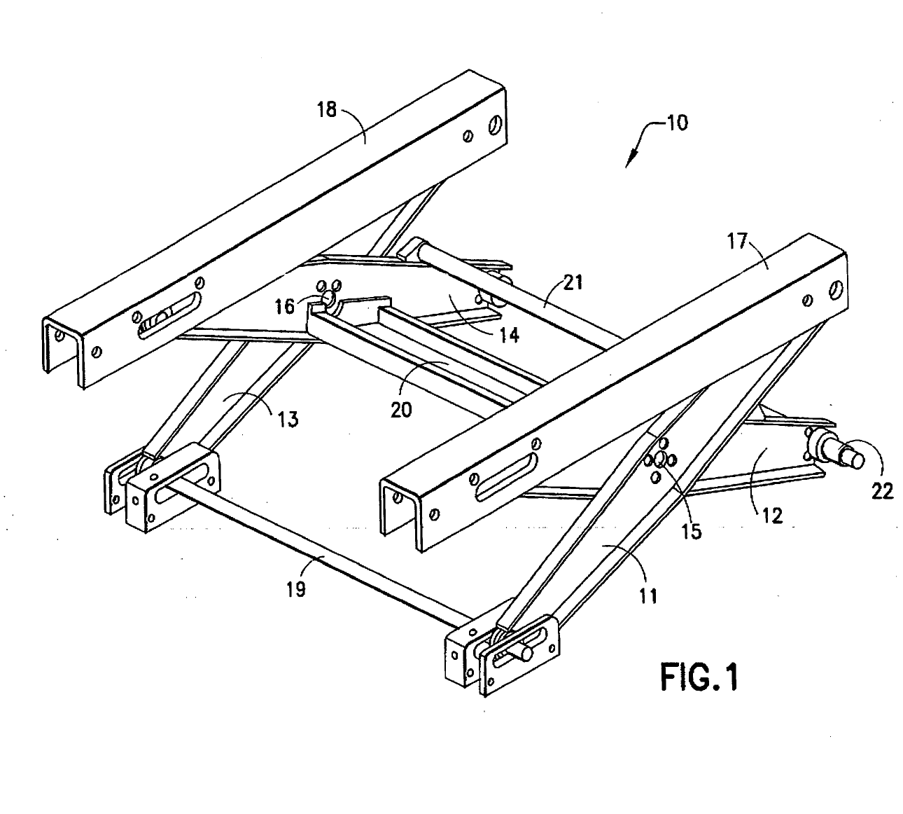

Referring to the truck seat suspension 10 of FIG. 1, the scissor linkages of suspension 10 have a pair of scissor arms 11 and 12 at one side and a further pair of scissor arms 13 and 14 at the other side. Each of arms 11, 12, 13 and 14 are formed as a single C-section channel member. Arms 11, 12 are pivotally connected at 15, and arms 13, 14 are likewise pivotally connected at 16. The upper ends of arms 11 and 12 are connected to inverted channel 17, as are the upper ends of arms 13 and 14 to inverted channel 18. The lower ends of arms 11, 12, 13 and 14 are connected to tracks and/or a mounting base plate (not shown) in a manner well known in the art. Cross rods and members 19, 20, 21 and 22 between the respective pairs of scissor arms are also well-known. The truck seat and any intervening mechanisms, both not shown, are mounted above and onto the inverted channels 17, 18 in known fashion. Further general description is not considered necessary in view of the known nature of such truck seat suspensions.

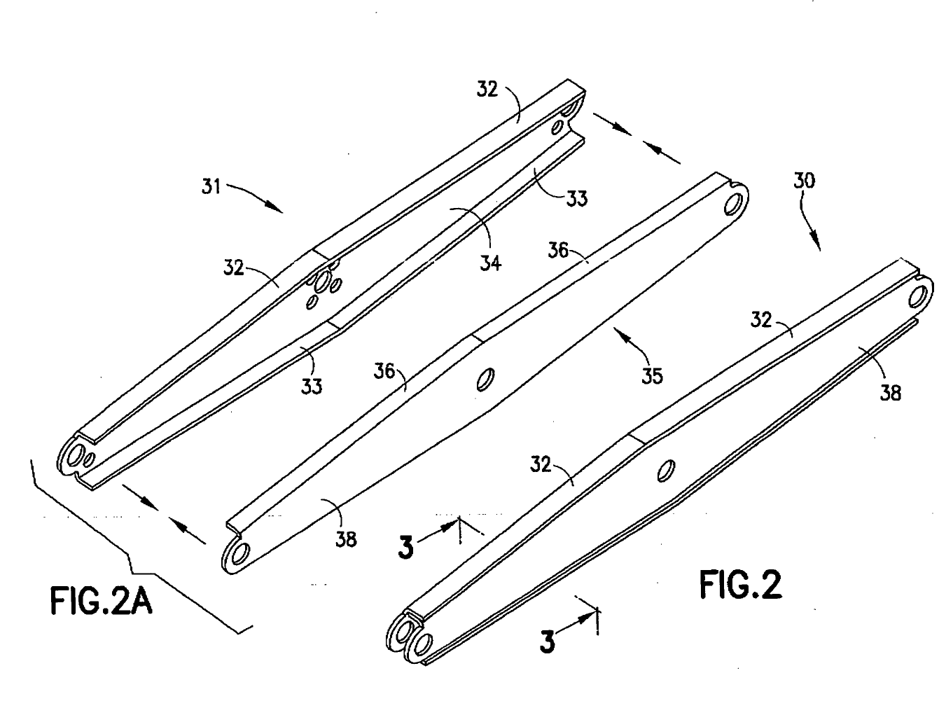

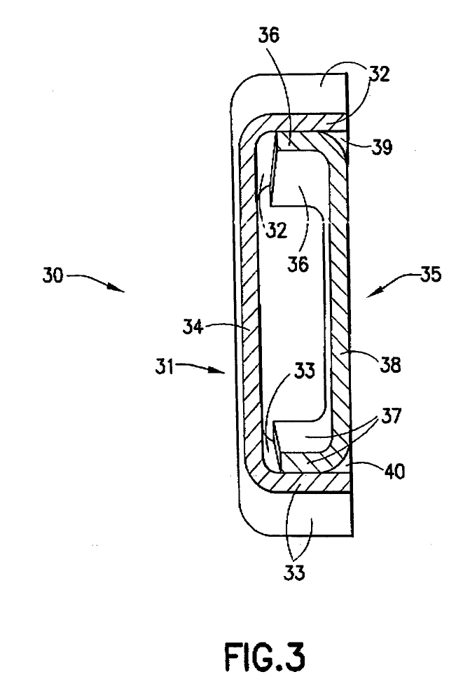

Now referring to FIGS. 2, 2A and 3, a reversed channel-in-channel scissor arm 30 of the present invention is formed by a first C-section channel member 31 having top and bottom lateral flanges 32, 33, and side flange 34 connecting said lateral flanges 32, 33; and by a second reversed-in-direction C-section channel member 35 having top and bottom lateral flanges 36, 37 and side connecting flange 38. Reversed channel member 35 is inserted into channel 31 as seen in FIGS. 2 and 3 with side flanges 34 and 38 increasing in top to bottom dimension from the respective ends of channels 31 and 35 to their central portions. Flanges 32 and 36 abut each other and flanges 33 and 37 likewise abut each other. Further, channel members 31 and 35 are welded to each other at positions 39 and 40 along the scissor arm 30, either by stitch welding at spaced locations or continuously along the scissor arm.

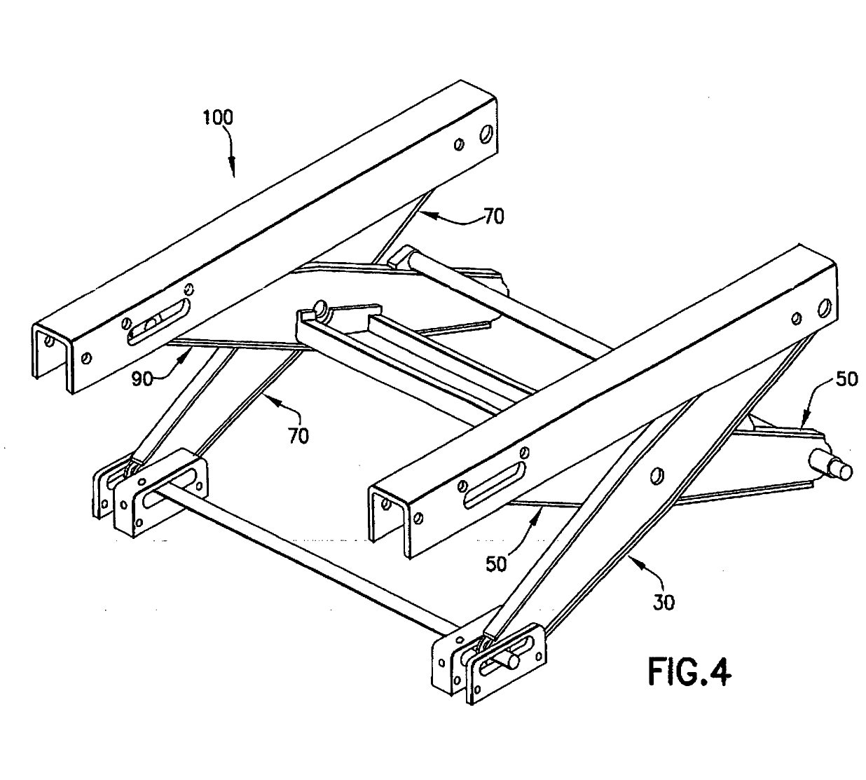

Referring to FIG. 4, channel-in-channel scissor arms 30, 50, 70 and 90 of the present invention are shown, with scissor arms 50, 70 and 90 being formed in the exact same manner as arm 30 described above. Truck seat suspension 100 in FIG. 4 otherwise corresponds to truck seat suspension 10 of FIG. 1. Although FIG. 4 has the side flange 38 of scissor arm 30 (and the corresponding side flange of scissor arm 50) facing outwardly of the suspension, these side flanges can face inwardly toward the center of the suspension solely for aesthetic reasons if desired.

The channel-in-channel scissor arms of the present invention corresponding to scissor arm 30 provide maximum bending stiffness approaching that of an I-beam due to the double flanges 32, 36 and 33, 37 at the top and bottom parts of each arm. Further, the welding together of flanges 32, 36 and 33, 37 obtains torsional properties approaching that of a tube. A very robust truck seat suspension is thereby provided which is suitable not only for all belts-to-seat truck seat suspensions but to truck seat suspensions generally because of the lateral stability provided.

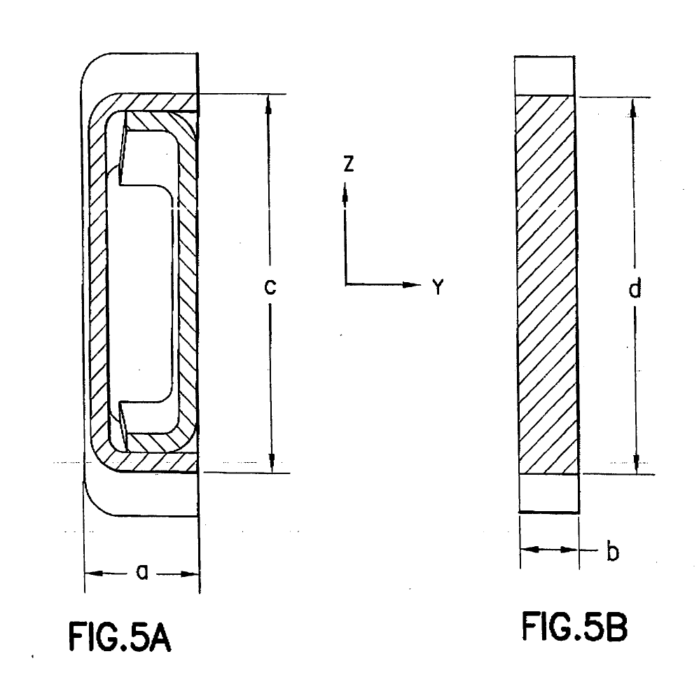

FIGS. 5A and 5B assist in demonstrating further benefits of the present invention. FIG. 5A shows a cross-section of the present invention corresponding to FIG. 3, to be compared with a corresponding cross-section of a solid section arm shown in FIG. 5B. Dimension a in FIG. 5A is 15 mm, dimension b in FIG. 5B is 8 mm, dimension c in FIG. 5A is 58 mm and dimension d in FIG. 5B is likewise 58 mm. The present invention of FIG. 5A has equivalent primary moments of inertia (I_{y}) to the solid section design of FIG. 5B. FIG. 5A provides over four times the secondary bending moment of inertia (I_{z}) of the solid section design of FIG. 5B; over three times the torsional constant (J) of the solid section design of FIG. 5B; and is over twenty percent lighter than the solid section design of FIG. 5B.

It will be appreciated by persons skilled in the art that variations and/or modifications may be made to the present invention without departing from the spirit and scope of the invention. The present embodiment is, therefore, to be considered as illustrative and not restrictive. While the invention has been disclosed in the context of a truck seat suspension, it is also applicable to seat suspensions for other industrial and other heavy duty vehicles.

What is claimed is:

1. A vehicle seat suspension with scissors linkages, each scissor having a pair of crossing scissor arms, each scissor arm comprising a first C-section channel member having its channel opening extending in a first lateral direction, a second C-section channel member having its channel opening extending in the opposite lateral direction, the second C-section channel member being positioned within the lateral opening of the first C-section channel member to provide a channel-in-channel scissor arm, and the first and second C-section channel members being welded to one another at positions along the scissor arm; whereby each scissor arm provides enhanced bending stiffness and torsional properties, enhanced lateral stability, and mass reduction.

2. The vehicle seat suspension of claim 1, wherein the first C-section channel member is dimensioned between its top and bottom lateral flanges to allow the second C-section channel member to nest therebetween, the top and bottom lateral flanges of the second C-section channel member abutting the top and bottom flanges of the first C-section channel member to provide double flanges at the top and bottom of each scissor arm, and the welding between the first and second C-section channel members occurring adjacent the abutting of the top flanges of the first and second C-section channel members and adjacent the abutting of the bottom flanges of the first and second C-section channel members.

3. The vehicle seat suspension of claim 2 wherein the dimensions between the top and bottom flanges of both the first and second C-section channel members increase from the ends of said channel members towards the central portions of said members.

4. The vehicle seat suspension of claim 2, wherein the second C-section channel member nests fully within the first C-section channel member.
